(19) United States
(12) Patent Application Publication
(10) Pub. No.: US 2013/0129313 A1
(43) Pub. Date: May 23, 2013

(54) PERSONALIZED STEREOSCOPIC IMAGE GENERATION

(71) Applicants: Andrew Jenkinson, Dublin 2 (IE); Niall O'Driscoll, Dublin 2 (IE); Lisa Tumbleton, Dublin 2 (IE); Sean Briton, Dublin 2 (IE)

(72) Inventors: Andrew Jenkinson, Dublin 2 (IE); Niall O'Driscoll, Dublin 2 (IE); Lisa Tumbleton, Dublin 2 (IE); Sean Briton, Dublin 2 (IE)

(73) Assignee: Mirror Brand Experiences Limited, Dublin 2 (IE)

(21) Appl. No.: 13/300,249

(22) Filed: Nov. 18, 2011

(51) Int. Cl. H04N 9/87

(52) U.S. Cl. 386/239; 386/E09.05

(57) ABSTRACT

A method that allows for generation of personalized stereoscopic motion pictures is described. The motion picture comprises a plurality of individual scenes are displayed in a predefined sequence. Such scenes may be generated from animation or other computer generated graphics, a filming of living actors or a combination of both. Once the scenes that define the motion picture are generated one or more of these scenes can then be combined in real-time with subsequently recorded images or image sequences to introduce a level of personalisation into the motion picture.

### FIELD

The present application relates to a method for generation of a personalized stereoscopic moving film.

### BACKGROUND

Stereoscopic technology is well known and relates to the generation of user-perceived three dimensional (3-D) effects. Typically the technology utilises techniques whereby a different image is presented to a user's left and right eyes. These offset images are then combined within the brain to give a user perception of 3-D depth. The technique may utilize specific displays which are capable of conveying a stereoscopic perception of the 3-D depth or may use specific glasses which are worn by the user.

To create the images that are then viewed, it is necessary to record the image sequence for each of the left and right eyes independently. These are then combined as part of the display process to generate the 3-D effect.

Examples include the 3-D films or stereoscopic moving films or motion pictures that can be produced through a variety of different methods. Within the present specification these terms will be used interchangeably along with the generic phrase movies. The term is intended to define movies generated through an animation or digital process or including living actors or a combination of one or more of the three types. The generation of these motion pictures in a controlled non-personalized fashion is known and these movies traditionally comprises a controlled series of images whose content is static and defined at the end of the post-production phase.

There is however a desire to extend the provision of such stereoscopic motion picture beyond the movie theatre environment and provide instead a level of personalisation of same. To date his has been difficult to achieve.

The information included in this Background section of the specification, including any references cited herein and any description or discussion thereof, is included for technical reference purposes only and is not to be regarded subject matter by which the scope of the invention as defined in the claims is to be bound.

### SUMMARY

These and other problems are addressed by a method that allows for generation of personalized stereoscopic motion pictures. Within the context of the present teaching the phrase “motion picture” is intended to define any type of extended image sequence whereby a plurality of individual scenes are displayed in a predefined sequence. Such scenes may be generated from animation or other computer generated graphics, a filming of living actors or a combination of both. In accordance with the present teaching a motion picture is generated and then combined in real-time with subsequently recorded images or image sequences to introduce a level of personalisation into the motion picture.

In one implementation a method of playing a stereoscopic image sequence is provided. A 3D image sequence comprising a sequence of frames associated with left and right eyes perspectives is read into a plurality of byte arrays, each of the byte arrays comprising RGBA data for individual left and right eye frames. During playback of the 3D image sequence, it is determined whether individual frames within the plurality of byte arrays are personalizable frames, the personalizable frames having one or more personalizable target regions defined therein. Previously stored personalized data is imported into memory, the personalized data being associated with specific personalizable target regions. Upon determination that an individual frame is personalizable, the RGBA of the byte arrays of the determined individual frame is processed to determine the location of the defined one or more personalizable target regions and mapping the personalized data to an appropriate personalizable target region to display in real time a personalized frame in which the personalizable frame has been merged with personalized data.

In another implementation a method of generating a stereoscopic image sequence for subsequent playback and concurrent merging with personalized data is provided. A 3D image sequence comprising a sequence of frames associated with left and right eyes perspectives is generated into a plurality of byte arrays, each of the byte arrays comprising RGBA data for individual left and right eye frames. Which of the sequence of frames are personalizable frames is defined within the 3D image sequence, the personalizable frames having one or more personalizable target regions defined therein. The personalizable target regions are processed to define a specific graphical identifier to allow subsequent location of said personalized data within a specific location of the personalizable target region.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings. Other advantageous embodiments are provided in the dependent claims.

### BRIEF DESCRIPTION OF THE DRAWINGS

The present application will now be described with reference to the accompanying drawings in which:

FIG. 1 is a flow sequence showing how a personalized stereoscopic image in accordance with the present teaching may be generated;

FIG. 2 is an example of a byte array comprising frame information for each of a left and right eye perspective;

FIG. 3A shows an example of a plurality of frames within a personalized shot;

FIG. 3B shows the example of FIG. 3A with personalized data included in the frames;

FIG. 4 shows a number of steps that may be adopted within the overall process flow of FIG. 1;

FIG. 5 shows a number of steps associated with a shading process in accordance with the present teaching; and

FIG. 6 is a schematic diagram of an exemplary computer processing system for implementing the generation of the personalized stereoscopic image.

### DETAILED DESCRIPTION OF THE DRAWINGS

The present teaching provides a system and method for generating a personalized stereoscopic experience for one or more users of the system. To assist in an understanding of the present teaching it will now be described with reference to an exemplary arrangement whereby a computer generated storyboard is developed using the C sharp programming language using XNA. It will be appreciated that C sharp is an example of a multi-paradigm programming language. XNA is a set of tools provided by Microsoft that has traditionally been used within video game development and management. The present disclosure should not be construed as being limited to applications developed with such specific software tools. To assist in an understanding of the nomenclature that is used within the present specification the following definitions will assist.

Script: the underlying plot or story to be transposed into a film or animation to define a moving picture.

Shot: a sequence of individual frames that collectively define a particular portion or scene of the script.

Frame: a film frame or video frame is one of the many individual still images which compose the complete moving picture. When the moving picture is displayed, each frame is flashed on a screen for a short time (usually 1/24th, 1/25th or 1/30th of a second) and then immediately replaced by the next one. The user's persistence of vision blends the frames together, producing the optical illusion of a moving image. Within the context of 3D personalized stereoscopic moving pictures individual frames for each of the left and right eye are generated and these are then played at an overall rate of 50 frames/second—with 25 left eye frames being interspersed by 25 right eye frames.

Personalized shot: a predefined sequence of frames intended to include personalized data.

Texture: graphical display elements, for example a frame in a movie or anything else that could be displayed by a graphics device.

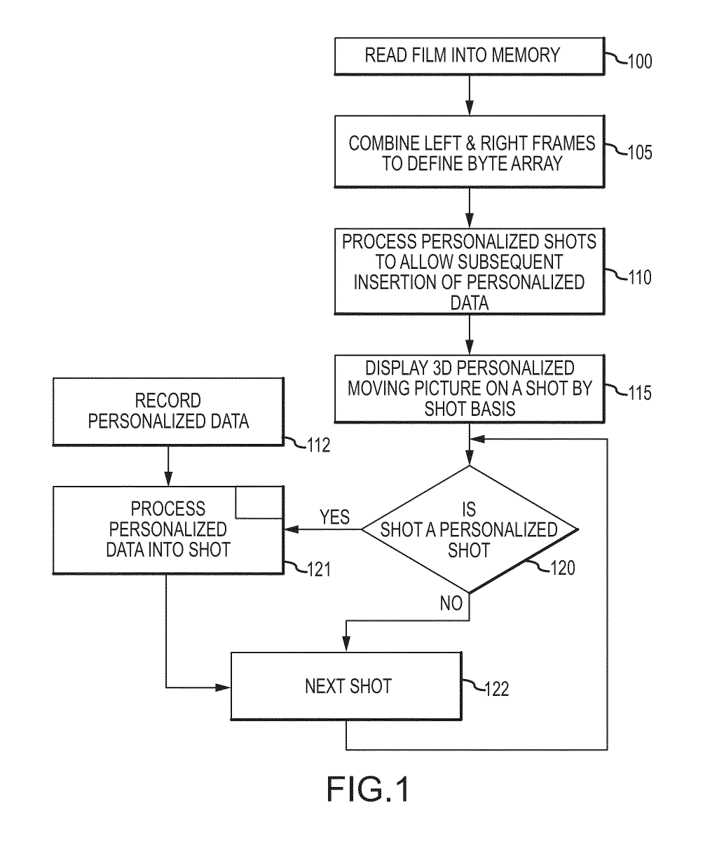

FIG. 1 shows an example of how a 3D personalized stereoscopic moving picture is created in accordance with the present teaching. The process can be considered a three-stage process with pre-production, production and post-production stages. As part of a pre-production a script is written and a shot list is defined for that script. The shot list comprises a plurality of identifiable shots and within that shot list, individual shots can be determined as being personalized shots. The shot-list is used to define the sequence of images that will ultimately form the 3D stereoscopic experience. This pre-production process is relatively conventional and will be understood as such by those of skill in the art. The pre-production process terminates with recording of a film.

Having created a film, the frames that make up that film are read into memory of a computer that will be used as part of the playback experience (Step 100). As this is a 3D film individual frames for each of the left and right eye are created and then read into the computer memory. Each of the left and right eye frames comprises 1280×720×4 bytes of data. The 4 bytes refer to the data pertaining to the RGB and Alpha constituents. It will be appreciated that the alpha channel is normally used as an opacity channel and by varying its value can be used to make it possible for pixels have a degree of transparency, for example to show through a background like a glass. Alpha channel values can be expressed as a percentage, integer, or real number between 0 and 1 like the other RGB parameters.

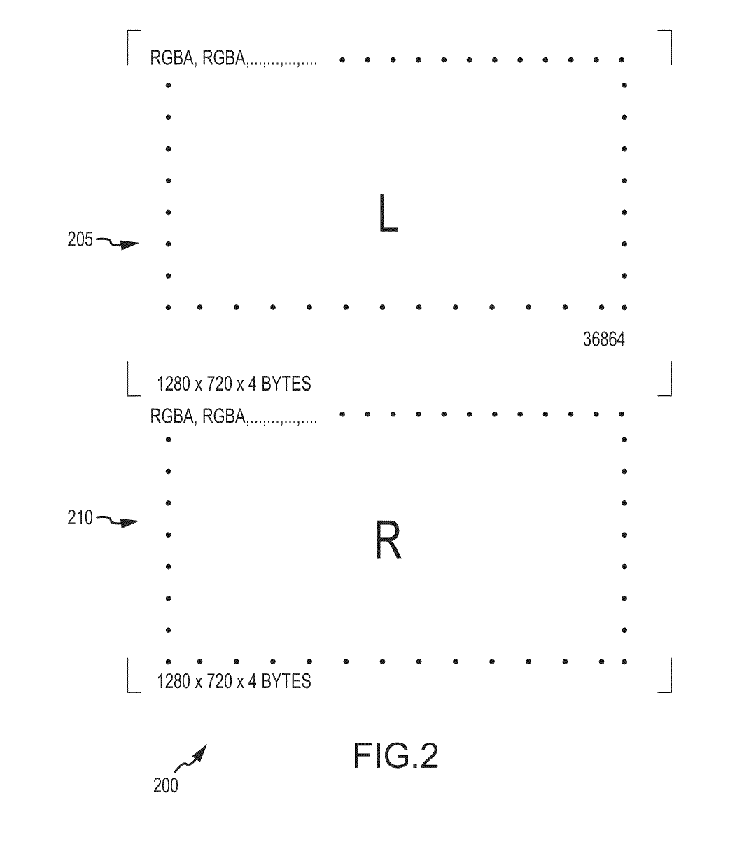

As shown in FIG. 2, the individual left and right frames are then combined to define a byte array (Step 105). This combination or rendering may for example be effected using HD res (1280*720) over under frame packing (1280*1440 pixels) so as to provide both left and right images in one frame 200, left on top 205, right on bottom 210, which can then be processed and turned into a frame sequential 3D stream. This processing may be done for example using C sharp which reads in the frame information and creates this frame sequential 3D stream combining the left and right eye data set. This processed video contains information which allows for the processing of occlusion or hidden surface determination in real time, as will be explained further below. It will be appreciated that occlusion is a technique which has traditionally been used in 3D computer gaming graphics to determine which surfaces and parts of a surface are not visible from a certain standpoint. By employing such techniques, the present teaching addresses a visibility problem in how to ensure which parts of a presented graphical element should be presented as a visible object to a viewer. It will be appreciated that two points in a space are said to be visible to one another if the line segment that joins the objects does not intersect any obstacles. In the context of the present teaching such information is critical for ensuring that when personalized data is subsequently inserted into the moving images that it is done in way which is consistent with what a viewer would expect.

As part of this processing the individual personalized shots are then processed.

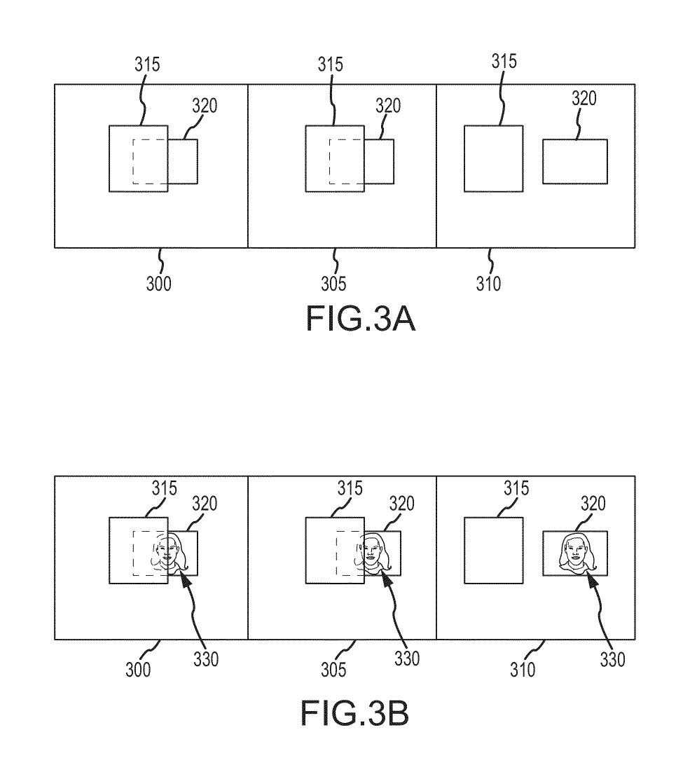

This processing allows for the insertion of personalized data as appropriate (Step 110). As the data set generated from processed content of Step 105 allows for the inclusion of occlusion data on a frame by frame basis, it is possible to identify within each shot, individual elements on a frame by frame basis which will form the template location for the personalized data—the personalized targets. FIG. 3A shows a simplified example of three such frames 300, 305, 310 which collectively are intended to define a personalized shot. In the example of FIG. 3 each of the frames comprises two elements, a first 315 and a second box 320. The intended sequence of the shot is to show the movement of a second box 320 from behind the first box 315 so as to be initially partially occluded by the first box—the first frame 300—to the final frame 310 where it is fully visible. As part of the personalisation process it is intended to provide a face 330 on the second box 320 that will gradually become fully visible as the frames are run through—as is shown in FIG. 3B.

In the set-up process of Step 110 the second box 320 is identified as a location for the insertion of the personalized data and a pre-defined graphical element is superimposed or layered onto a portion of that box on which the personalized data is intended to be placed. The graphical element may be a simple coloured box whose colour will be identifiable during further processing the of the data as the intended personalized location. Ideally the pre-defined graphical element is mapped with a relational algorithm such that its orientation relative to the second box will be retained during movement of the second box to the first box. This will allow for rotation of the pre-defined graphical element on an x-y-z rotational basis. As this mapping is predefined, the subsequent layering of a personalized data item onto that graphical element will allow the personalized data item to also adopt the same movement. These elements and their associated intended display pattern are then hard coded or baked into the video sequence. This allows the system to subsequently generate 3D personalized occluded content using only one video as a source data set.

As part of the personalisation experience, the present teaching provides for the recordal of personalized data (Step 112). This may be in the form of ASCII text such as the name or other associated data for an individual. It may include a static graphical image such as a photograph or other digital image format image of an individual. It may include a sound file recording voice or some other audible parameter that will be associated with the user. It may also include moving data—such as a video. One or more of these personalized data elements may be recorded. They are then tagged for inclusion in specific frames or scenes of the pre-recorded image sequence.

In generating the 3D stereoscopic movie (Step 112), the movie player of the present teaching is configured to combine the personalized data from step 112 with the pre-defined graphical element from step 110 in a real time display.

As shown in FIG. 1 when processing the frames (step 115), the system and methodology provides for the identification, during real-time playback, of specific personalized shots for processing (Step 120). As the location of the personalized data is known from the shot sequence, on executing the film through the player, the system is configured to identify specific frames which have been predetermined as being personalized frames. If the shot is identified as being a personalized shot (Step 121), then the personalized data from Step 112 is combined into the defined frames of Step 110. This combination includes the retrieval from memory of the personalized data from step 112 and combination of same that with the pre-defined graphical element from step 110.

The process then continues to the next shot (step 122). In an iterative process the player will process all shots of the movie until the end.

This provides a real-time incorporation and simultaneous display of the personalized stereographic image sequence which forms the movie.

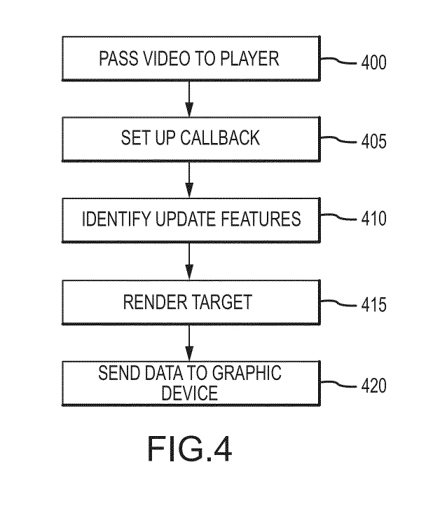

FIG. 4 shows an example of the process flow adopted within the generic process of Step 115. As the teaching is concerned with providing both left and right eye image sequences which are then processed by the brain to create the illusion of a 3D effect, the following which is described with respect to one eye only, will be appreciated as applying to both eyes.

In step 200, a player such as an nVLC player is passed the raw 1280*1440 video frames that were illustrated with respect to FIG. 2. It will be appreciated that the nVLC player is a specific .NET API for the IibVLC (Videolans video playing software) interface which allows VLC functionality to be utilized in managed applications. It is not intended to limit the present teaching to this specific example of player.

In step 205 a callback is set up on the player. A callback can be considered an event handler which is called each time a new frame is ready for display. The callback is configured to pass in a pointer (which points to an address in memory) to an unmanaged byte array which contains the memory address of the pixel information for each frame. The byte array contains 1280*1440*4 bytes, each 4 bytes containing RGBA (Red, Green, Blue, Alpha) information for each frame.

As part of the processing the system is configured to determine which elements of which frames are to be updated (Step 210). Having determined which frames are to be updated, a preferred update methodology which may be provided for example using an XNA framework, constantly runs when the application is running, 50 times per second. It will be appreciated that this refresh frequency is a standard speed of a refresh rate for a 3D display device and comprises a the sequential presentation of left and right frames at 25 frames/second.

Based on the sequential playing of left and right eye data alternatively the system is configured to determine which camera (left or right) should be drawn or presented to the display device. The texture, i.e. graphical display elements, for example a frame in a movie or anything else that could be displayed by the graphics device, that is drawn to screen at that time is updated based on the relevant pixel information from the byte array. For example, if the left camera should be drawn, we take information at position 0 in the array up to position 3686400 (1280*720*4). If the right camera should be drawn, we take information starting at position 3686400 in the array until the end (7372800). This happens 50 times per second, with 25 calculations for each eye.

This information is then drawn to a render target (which creates a picture based on the bytes in the byte array) (Step 215) and is sent to the graphics device, which allows a 3D display to render stereoscopic visuals on screen (Step 220).

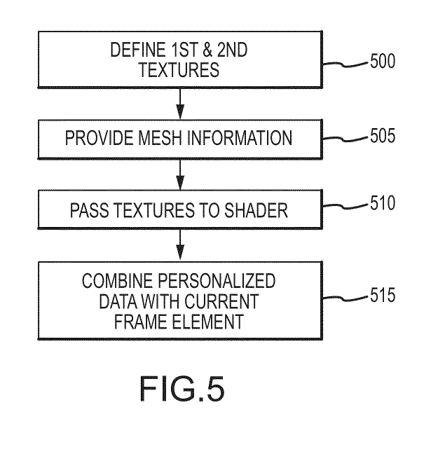

FIG. 5 shows an example of the specific technique that is adopted for those scenes which are to be personalized. As the content is personalized, the personalized data—for example user images—are drawn on top of the pre-recorded content. In order to create a realistic visual aesthetic, it is imperative that other objects in the content can pass over and can appear to ‘overlay’ these pictures, as they would in real life. This is achieved as follows:

Define first and second textures (Step 300). The first texture is defined as the texture of the current frame (I or r) of the video being played. The second texture is a render target of the customisable images which were defined as part of the processing of the personalized shots (Step 110) and comprises a 3D mesh data set.

This 3D mesh comprises polygon information for the placement, scale and rotation of this personalized data set. This mesh is stored in for example 3D Studio Max which is an example of a 3D modeling and animation software package that may be usefully employed within the context of the present teaching contains ONLY the information pertaining to the customisable image placement. As part of the personalisation process this mesh is then drawn to the render target (Step 305) The render target, the predefined graphical element discussed with reference to FIG. 3 above, has an alpha channel value which makes it transparent in the absence of a mesh.

The defined first and second textures are then passed to a shader utility (Step 310). Such a shader utility may comprise for example a bespoke higher level shading language (HLSL) shader in XNA which takes the information from both textures and deciphers which pixels of the customisable render target (which contains the personalisation data) to combine with the texture of the current frame (Step 315). For example, if the shader detects a predefined RGB value in the current frame (e.g. bright red) it will draw the content of the customisable render target on top of the current frame texture. This allows overlaying of the personalisation with occlusion in real time.

The above methodology references a pointer to the data of the RGBA pixel information which is storeable in unmanaged memory elements of the computing device executing the software utility. This is then converted to a managed memory in the form of a byte array of the RGBA data. The processing is then conducted on the processed managed data. By adopting this approach the present inventors have implemented a system which is about 75% less computationally intensive than other techniques and allows for the real time generation of the personalized image sequence without requiring specialist computing hardware.

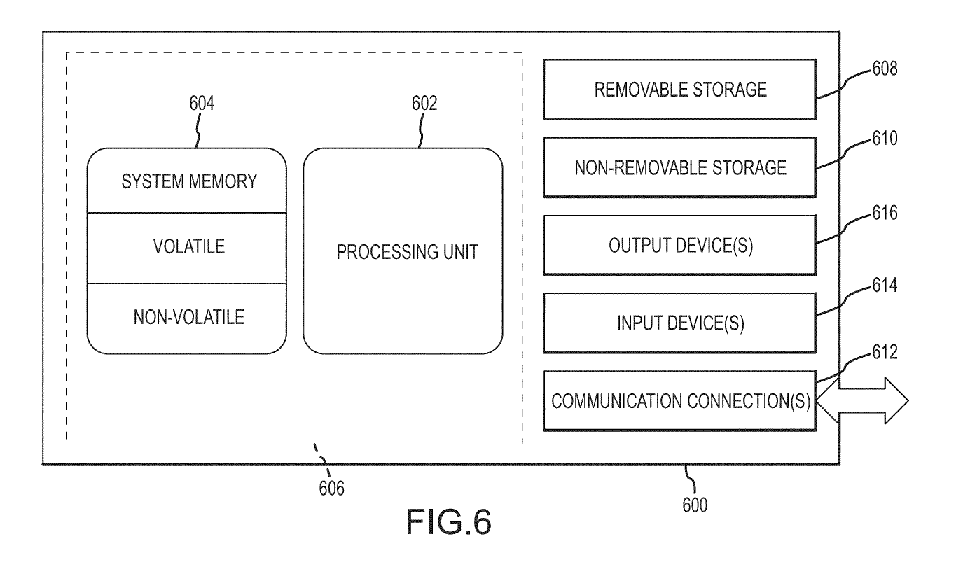

FIG. 6 illustrates an exemplary computer system or other processing device 600 (e.g., a frame player) configured by the stereoscopic image generation and playback instructions as described herein. In one implementation, the processing device 600 typically includes at least one processing unit 602 and memory 604. Depending upon the exact configuration and type of the processing device 600, the memory 604 may be volatile (e.g., RAM), non-volatile (e.g., ROM and flash memory), or some combination of both. The most basic configuration of the processing device 600 need include only the processing unit 602 and the memory 604 as indicated by the dashed line 606. A primary or base operating system controlling the basic functionality of the processing device 600 in the nonvolatile memory 604.

The processing device 600 may further include additional devices for memory storage or retrieval. These devices may be removable storage devices 608 or non-removable storage devices 610, for example, memory cards, magnetic disk drives, magnetic tape drives, and optical drives for memory storage and retrieval on magnetic and optical media. Storage media may include volatile and nonvolatile media, both removable and non-removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the processing unit 602. Additional instructions, e.g., in the form of software, that interact with the base operating system to create a special purpose processing device 600, in this implementation, instructions for generation or playback of frames to create the described stereoscopic effects, may be stored in the memory 604 or on the storage devices 610 using any method or technology for storage of data, for example, computer readable instructions, data structures, and program modules.

The processing device 600 may also have one or more communication interfaces 612 that allow the processing device 600 to communicate with other devices. The communication interface 612 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 612 over the network via a modulated data signal, e.g., a carrier wave or other transport medium. A modulated data signal is an electromagnetic signal with characteristics that can be set or changed in such a manner as to encode data within the signal.

The processing device 600 may further have a variety of input devices 614 and output devices 616. Exemplary input devices 614 may include a video camera, recorder, or playback unit, a keyboard, a mouse, a tablet, and/or a touch screen device. Exemplary output devices 616 may include a video display, audio speakers, and/or a printer. Such input devices 614 and output devices 616 may be integrated with the computer system 600 or they may be connected to the computer system 600 via wires or wirelessly, e.g., via IEEE 802.11 or Bluetooth protocol. These integrated or peripheral input and output devices are generally well known and are not further discussed herein. Other functions, for example, handling network communication transactions, may be performed by the operating system in the nonvolatile memory 604 of the processing device 600.

The words comprises/comprising when used in this specification are to specify the presence of stated features, integers, steps or components but does not preclude the presence or addition of one or more other features, integers , steps, components or groups thereof.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the invention. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of playing a stereoscopic image sequence comprising
reading a 3D image sequence comprising a sequence of frames associated with left and right eyes perspectives into a plurality of byte arrays, each of the byte arrays comprising RGBA data for individual left and right eye frames;
determining, during playback of the 3D image sequence, whether individual frames within the plurality of byte arrays are personalizable frames, the personalizable frames having one or more personalizable target regions defined therein;
importing previously stored personalized data into memory, the personalized data being associated with specific personalizable target regions; and
on determination that an individual frame is personalizable, processing the RGBA of the byte arrays of the determined individual frame to determine the location of the defined one or more personalizable target regions and mapping the personalized data to an appropriate personalizable target region to display in real time a personalized frame in which the personalizable frame has been merged with personalized data.

2. The method of claim 1, wherein the personalizable frames are arranged in one or more personalizable shots, a personalizable shot comprising a plurality of personalizable frames.

3. The method of claim 2, wherein the determination that an individual frame is personalizable comprises identifying a personalizable shot.

4. The method of claim 1, wherein a personalizable target region comprises a predefined graphical element.

5. The method of claim 4, wherein the predefined graphical element is defined by a predetermined RGB value.

6. The method of claim 5, wherein the predefined graphical element has an alpha value which in the absence of the mapping of the personalized data to the predefined graphical element renders the predefined graphical element transparent.

7. The method of claim 4, wherein a personalizable target region is associated with a 3D mesh comprising polygon information for at least one of the placement, scale and rotation of mapped personalized data and wherein during the mapping process the 3D mesh is drawn to the personalizable target region.

8. The method of claim 7, wherein mapping of the personalized data to the personalizable target region associates the personalized data with the 3D mesh such that the personalized data is moveable within a displayed sequence of frames.

9. The method of claim 8, wherein the personalized data is moveable relative to other elements within the personalizable frame.

10. The method of claim 1, wherein the personalizable target region and the personalized data are each defined by first and second textures respectively and wherein during the mapping each of the first and second textures are processed by a shader utility which takes information from the first and second textures and deciphers which pixels of each of the textures are to be combined to define the personalized frame.

11. A method of generating a stereoscopic image sequence for subsequent playback and concurrent merging with personalized data, the method comprising
generating a 3D image sequence comprising a sequence of frames associated with left and right eyes perspectives into a plurality of byte arrays, each of the byte arrays comprising RGBA data for individual left and right eye frames;
defining within the 3D image sequence which of the sequence of frames are personalizable frames, the personalizable frames having one or more personalizable target regions defined therein; and
processing the personalizable target regions to define a specific graphical identifier to allow subsequent location of said personalized data within a specific location of the personalizable target region.

12. The method of claim 11 comprising tagging individual personalizable target regions to allow a subsequent association of those target regions with specific personalized data.

13. The method of claim 12 comprising recording personalized data for subsequent merging with specific personalized target regions.

14. The method of claim 13 comprising tagging the personalized data to associate specific personalized data with specific personalized target regions.

15. The method of claim 11 comprising arranging the personalizable frames in one or more personalizable shots, a personalizable shot comprising a plurality of personalizable frames.

16. The method of claim 15, wherein a first frame of a personalized shot is tagged to allow a subsequent determination that a personalized shot is next in the sequence of frames being displayed.

17. The method of claim 11, wherein the specific graphical identifier is a predetermined RGB value.

18. The method of claim 17, wherein the graphical identifier has an alpha value which in the absence of the mapping of personalized data to the graphical identifier renders the graphical identifier transparent.

19. The method of claim 11, wherein the graphical identifier is associated with a 3D mesh comprising polygon information for at least one of the placement, scale and rotation of mapped personalized data.

20. The method of claim 19, wherein the 3D mesh is configured to allow subsequently merged personalized data to be moveable relative to other elements within the personalizable frame.

21. The method of claim 11, wherein the personalizable target region is defined by a first texture which during a subsequent mapping of personalized data to the personalizable region is processed by a shader utility which takes information from the first texture and deciphers which pixels of the first textures are to be combined with pixels of the personalized data to define the personalized frame.
